(19) United States
(12) Patent Application Publication
(10) Pub. No.: US 2014/0076109 A1
(43) Pub. Date: Mar. 20, 2014

(54) INTEGRATED ROTARY CABLE STRIPPER

(71) Applicant: Changzhou Amphenol Fuyang Communication Equip. Co., Ltd., Changzhou (CN)

(72) Inventors: Pengjin Wang, Changzhou (CN); Tingxing SHENG, Changzhou (CN)

(73) Assignee: Changzhou Amphenol Fuyang Communication Equip. Co., Ltd., Changzhou (CN)

(21) Appl. No.: 13/899,130

(22) Filed: May 21, 2013

(30) Foreign Application Priority Data
Sep. 17, 2012 (CN) 201220471460.9

(51) Int. Cl. H02G 1/12

(52) U.S. Cl. CPC H02G 1/1221
USPC 81/9.4

(57) ABSTRACT

An integrated rotary cable stripper that includes a substantially cylindrical body having an inner wall and two opposing ends, a cable jacket stripper received within in the inner wall of the body, an outer conductor stripper received within the inner wall of the body, an inner conductor cutter received within the inner wall of the body, and an inner conductor chamfer turning cutter received within the inner wall of the body, wherein the cable jacket stripper, outer conductor stripper, inner conductor cutter, and inner conductor chamfer turning cutter integrate the functions to strip a cable.

### RELATED APPLICATIONS

The present application claims priority under 35 U.S.C. §119 to Chinese Patent Application No. 201220471460.9, filed Sep. 17, 2012, the entire disclosure of which is incorporated herein by reference.

### FIELD OF THE INVENTION

The present application relates to a cable stripper, and more particularly to a cable stripper that integrates all of the functions required for stripping cable.

### BACKGROUND OF THE INVENTION

At present, high market demand for communication equipment products requires mass production of associated cable. However, current cable strippers do not have all the functions of stripping the cable jacket and outer conductor, cutting and cross-sectioning the inner conductor and chamfering the inner conductor, required to strip cable. As a result, the conventional process for stripping cable requires multiple steps and multiple tools.

Therefore, a need exists for a cable stripper that has all of the functions for stripping cable such that the cable can be stripped in one step using a single tool.

### SUMMARY OF THE INVENTION

Accordingly, the present invention relates to an integrated rotary cable stripper that includes a substantially cylindrical body that has an inner wall and two opposing ends, a cable jacket stripper that is received within the inner wall of the body, an outer conductor stripper that is received within the inner wall of the body, an inner conductor cutter that is received within the inner wall of the body, and an inner conductor chamfer turning cutter that is received within the inner wall of the body. The cable jacket stripper, the outer conductor stripper, the inner conductor cutter, and the inner conductor chamfer turning cutter integrate the functions to strip a cable.

The present invention also provides an integrated rotary cable stripper that includes a substantially cylindrical body that has an inner wall and two opposing ends, a cable jacket stripper that is received within the inner wall of the body, an outer conductor stripper that is received within the inner wall of the body, an inner conductor cutter that is received within the inner wall of the body, an inner conductor chamfer turning cutter that is received within the inner wall of the body, a cable stripper guide that is coupled to one of the opposing ends of the substantially cylindrical body, a hexangular end cap connection handle that has an end face that is coupled to the other of the opposing ends of the substantially cylindrical body and has a substantially hexagonal projection that has a length extending therefrom, and a marble slot that is provided in the length of the substantially hexagonal projection. The cable jacket stripper, the outer conductor stripper, the inner conductor cutter, and the inner conductor chamfer turning cutter integrate the functions to strip a cable.

The present invention further provides a method of stripping a cable, including the steps of providing a cable that has a jacket, an outer conductor and an inner conductor, providing a cable stripper that includes a substantially cylindrical body that has an inner wall and two opposing ends, a cable jacket stripper that is received within the inner wall of the body, an outer conductor stripper that is received within the inner wall of the body, an inner conductor cutter that is received within the inner wall of the body, and an inner conductor chamfer turning cutter that is received within the inner wall of the body, inserting a cable into the cable stripper, rotating the cable such that it advances to the cable jacket stripper, stripping the jacket using the cable jacket stripper, advancing the cable further to the outer conductor stripper which strips the outer conductor while the cable jacket stripper is stripping the jacket, advancing the cable further to the inner conductor chamfer turning cutter which chamfers the inner conductor, while the cable jacket stripper is stripping the cable jacket and the outer conductor stripper is stripping the outer conductor, advancing the cable further to the inner conductor cutter which cuts and cross-sections the inner conductor, while the cable jacket stripper is stripping the cable jacket, the outer conductor stripper is stripping the outer conductor, and the inner conductor chamfer turning is chamfering the inner conductor, and advancing the cable further to a pre-determined end position whereby the jacket and outer conductor are completely stripped, and the inner conductor is chamfered, cut and cross-sectioned.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is side view of a cable stripper according to an exemplary embodiment of the present invention, showing a portion of the cable stripper in cross-section;

FIG. 2 is a perspective view of the cable stripper illustrated in FIG. 1; and

FIG. 3 is a side view of the cable stripper illustrated in FIG. 1, showing a handle assembly attached thereto, and a portion of the cable stripper and handle assembly in cross-section.

### DETAILED DESCRIPTION OF THE EXEMPLARY EMBODIMENTS

Referring to FIGS, 1-3, an integrated rotary cable stripper 100, according to an exemplary embodiment of the present invention, integrates all functions required to strip a cable (not shown), including stripping the cable jacket and its outer conductor, cutting and cross-sectioning the cable's inner conductor and chamfering the inner conductor of the cable. The cable stripper 100 is preferably used for stripping coaxial cable that has either a spiral or flat outer conductor.

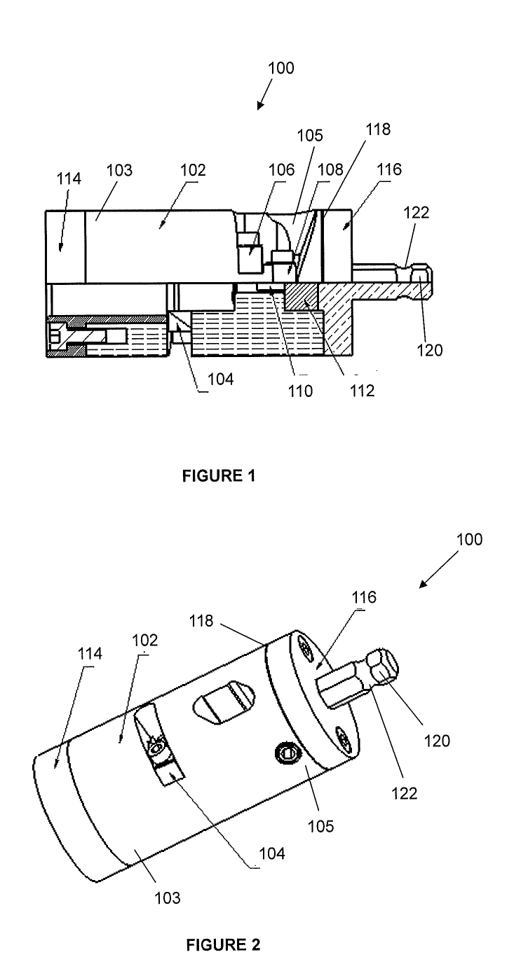

As seen in FIGS. 1 and 2, the integrated rotary cable stripper 100 of the present invention generally comprises a substantially cylindrical body 102, a cable jacket stripper 104 for stripping the cable's jacket, an outer conductor stripper 106 for stripping the cable's outer conductor, an inner conductor cutter 108 for cutting and cross-sectioning the cable's inner conductor, and an inner conductor chamfer turning cutter 110 for chamfering the cable's inner conductor. The inner conductor chamfer turning cutter 110 generally includes a blade positioned at an angle, so it rotates forward as it cuts. One end of the inner conductor chamfer turning cutter 110 may be attached to the base 112, such as by crimping, and the base 112 may be coupled to the body 102. The base 112 may be coupled to the body 102 using side screws (not shown), although any coupling mechanism known to one skilled in art may be used. The substantially cylindrical body 102 has two opposing ends and an inner wall therebetween. The cable jacket stripper 104, outer conductor stripper 106, inner conductor cutter 108 and inner conductor chamfer turning cutter 110 may be positioned in the inner wall of the body 102. According to one embodiment, the cable jacket stripper 104, the outer conductor stripper 106, and the inner conductor cutter 108 may be fixed on the body 102 via screws (not shown). However, any coupling mechanism known to one skilled in the art may be used.

The cable stripper 100 may further include a cable stripper guide 114 and an end cap connection handle 116. Preferably, the cable stripper guide 114 is coupled to one end 103 of the body 102. The guide 114 may be coupled to the body 102 by a screw, for example. In operation, a cable (not shown) is inserted into a guiding part (not shown) within the guide 114. The end cap connection handle 116 has an end face 118, which is preferably coupled to the other end 105 of the body 102, and a substantially hexagonal projection 120 having a length extending therefrom. A marble slot 122 is positioned on the substantially hexagonal projection 120 and allows the cable stripper 100 to be connected to a handle assembly 200.

The cable (not shown) is inserted into the guiding part of the cable stripper guide 114. As the cable is rotated, it advances forward (to the right in FIG. 1) relative to the cable stripper 100. The cable jacket stripper 104 begins to strip the cable jacket. Next, while the cable jacket stripper 104 is still stripping the cable jacket, the outer conductor stripper 106 begins to strip the outer conductor of the cable. The inner conductor chamfer turning cutter 110 then begins chamfering the inner conductor of the cable while the cable jacket stripper 104 is still stripping the cable jacket, and also while the outer conductor stripper 106 is still stripping the outer conductor of the cable. The inner conductor cutter 108 also begins to cut and cross-section the inner conductor of the cable while the cable jacket stripper 104 is still stripping the cable jacket, the outer conductor stripper 106 is stripping the outer conductor, and the inner conductor chamfer turning cutter 110 is still chamfering the inner conductor of the cable. The cable is then rotated to a predetermined end position, whereby the cable jacket and outer conductor are stripped to a desired position, and the inner conductor is chamfered, cut and cross-sectioned.

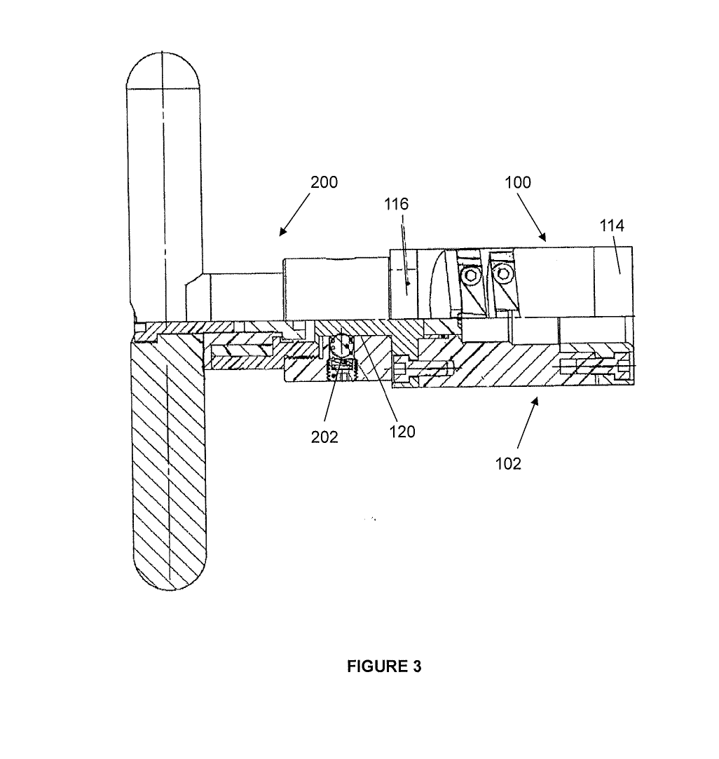

The cable stripper 100 may be used in conjunction with a unidirectional rotary stripper handle assembly or an electric rotary driver. As shown in FIG. 3, the cable stripper 100 is coupled to a unidirectional rotary stripper handle assembly 200, which allows a user to rotate the cable stripper about the cable (not shown). The unidirectional rotary stripper handle assembly 200 may engage the hexangular end cap connection handle 116 by connecting to the substantially hexagonal projection 120. Specifically, the substantially hexagonal projection 120 may be inserted into a through hole (not shown) within the unidirectional rotary stripper handle assembly 200. A marble/spring assembly 202 located within the unidirectional rotary stripper handle assembly 200 engages the marble slot 122 on the substantially hexagonal projection 120. The springs of the marble/spring assembly 202 exert force upon the marbles, and the marbles in turn exert force on the cable stripper projection 120, such that the cable stripper 100 is held in place. To be sure, the force exerted by the marbles on the marble slot 122 must be greater than the force of gravity acting to pull the cable stripper projection 120 out of the through hole. In this way, the cable stripper 100 can be coupled to the handle assembly 200. The cable stripper 100 can then easily be removed simply by pulling on the unidirectional rotary stripper handle assembly 200 (or cable stripper 100) with enough force to disengage the marbles from the marble slot 122 on the cable stripper projection 120. This method of connection does not require any other tools to assemble or disassemble.

Compared with the conventional strippers, the stripper 100 of the present invention is simple in structure, easy to assemble and disassemble, and integrates all functional requirements for stripping cable. By using a rotary cutting technique, as discussed above, the stripper 100 integrates the cable jacket stripper 104, outer conductor stripper 106, inner conductor cutter 108 and inner conductor chamfer turning cutter 110 and the functions of each. When the stripper 100 is used, because of its integrated structure, it can finish all stripping operations including stripping the cable jacket and the outer conductor, cutting the inner conductor and chamfering the inner conductor. The stripped cable can then be sent directly to the next process without need of other processing to the cable.

While particular embodiments have been chosen to illustrate the invention, it will be understood by those skilled in the art that various changes and modifications can be made therein without departing from the scope of the invention as defined in the appended claims.

1. An integrated rotary cable stripper, comprising:
a substantially cylindrical body having an inner wall and two opposing ends;
a cable jacket stripper received within said inner wall of said body;
an outer conductor stripper received within said inner wall of said body;
an inner conductor cutter received within said inner wall of said body; and
an inner conductor chamfer turning cutter received within said inner wall of said body,
wherein said cable jacket stripper, said outer conductor stripper, said inner conductor cutter, and said inner conductor chamfer turning cutter integrate the functions to strip a cable.

2. The integrated rotary cable stripper of claim 1, further comprising
a cable stripper guide coupled to one of said opposing ends of said substantially cylindrical body; and
an end cap connection handle having an end face coupled to the other of said opposing ends of said substantially cylindrical body.

3. The integrated rotary cable stripper of claim 2, wherein
said end cap connection handle being hexangular and having a substantially hexagonal projection including a length extending therefrom.

4. The integrated rotary cable stripper of claim 3, further comprising
a marble slot provided in said substantially hexagonal projection.

5. An integrated rotary cable stripper, comprising:
a substantially cylindrical body having an inner wall and two opposing ends;
a cable jacket stripper received within said inner wall of said body;
an outer conductor stripper received within said inner wall of said body;
an inner conductor cutter received within said inner wall of said body;
an inner conductor chamfer turning cutter received within said inner wall of said body;
a cable stripper guide coupled to one of said opposing ends of said substantially cylindrical body;
a hexangular end cap connection handle having an end face coupled to the other of said opposing ends of said substantially cylindrical body and having a substantially hexagonal projection having a length extending therefrom; and
a marble slot provided in said length of said substantially hexagonal projection,
wherein said cable jacket stripper, said outer conductor stripper, said inner conductor cutter, and said inner conductor chamfer turning cutter integrate the functions to strip a cable.

6. A method of stripping a cable, comprising the steps of:
providing a cable having a jacket, an outer conductor and an inner conductor;
providing a cable stripper, including:
a substantially cylindrical body having an inner wall and two opposing ends;
a cable jacket stripper received within the inner wall of the body;
an outer conductor stripper received within the inner wall of the body;
an inner conductor cutter received within the inner wall of the body; and
an inner conductor chamfer turning cutter received within the inner wall of the body;
inserting a cable into cable stripper;
rotating the cable stripper such that it advances relative to the cable;
stripping the jacket using the cable jacket stripper;
advancing the cable stripper further to the outer conductor stripper which strips the outer conductor while the cable jacket stripper is stripping the jacket;
advancing the cable stripper further to the inner conductor chamfer turning cutter which chamfers the inner conductor, while the cable jacket stripper is stripping the cable jacket and the outer conductor stripper is stripping the outer conductor;
advancing the cable stripper further to the inner conductor cutter which cuts and cross-sections the inner conductor, while the cable jacket stripper is stripping the cable jacket, the outer conductor stripper is stripping the outer conductor, and the inner conductor chamfer turning is chamfering the inner conductor; and
advancing the cable stripper further to a pre-determined end position whereby the jacket and outer conductor are completely stripped, and the inner conductor is chamfered, cut and cross-sectioned.

7. The method of stripping a cable of claim 6, wherein
the cable stripper further includes a cable stripper guide coupled to one of the opposing ends of the substantially cylindrical body, the cable stripper guide having a guiding part, and the step of inserting the cable into the cable stripper includes inserting the cable into the guiding part of the cable stripper guide.

8. (canceled)

9. The method of stripping a cable of claim 7, wherein
a handle is provided on the cable stripper at the other end of the substantially cylindrical body.
